(19) United States
(12) Patent Application Publication
(10) Pub. No.: US 2024/0263579 A1
(43) Pub. Date: Aug. 8, 2024

(54) DRIVE SYSTEM, AND AIRCRAFT INCLUDING A DRIVE SYSTEM

(71) Applicant: MTU Aero Engines AG, Muenchen (DE)

(72) Inventors: Istvan BOLGAR, Sengenthal (DE); Alexander WOITALKA, Munich (DE)

(21) Appl. No.: 18/639,770

(22) Filed: Apr. 18, 2024

(30) Foreign Application Priority Data
Apr. 21, 2023 (DE) 102023110273.7
Nov. 24, 2023 (DE) 102023132900.6

(51) Int. Cl. F02C 3/34; F02C 7/141

(52) U.S. Cl. CPC F02C 3/34; F02C 7/141

(57) ABSTRACT

A drive system (10) including a gas turbine (1), designed in particular as an aircraft engine. The gas turbine (1) includes a core flow channel (1c) in which at least one compressor (2), in particular a mixing chamber (3a), a combustion chamber (3), and a turbine (4), are situated in the flow direction, and a steam system (20) for separating water from an exhaust gas stream of the core flow channel (1c), for generating steam, and for conveying the steam, in particular across the mixing chamber (3a) into the combustion chamber (3). A drive system (10) whose efficiency is increased is provided in that the steam system (20) is coupled to a separate cooling system (30) in order to contribute to the separation of the water for generating the steam from an exhaust gas stream of the core flow channel (1c), via absorption and discharge of heat.

This claims priority to German Patent Applications DE 102023110273.7, filed on Apr. 21, 2023 and DE 102023132900.6, filed on Nov. 24, 2023, all of which are hereby incorporated by reference herein.

### BACKGROUND

The present invention relates to a drive system that includes a gas turbine, designed in particular as an aircraft engine, the aircraft engine including a core flow channel in which at least one compressor, in particular a mixing chamber, a combustion chamber, and a turbine, are situated in the flow direction, and including a steam system for separating water from an exhaust gas stream of the core flow channel, for generating steam, and for conveying the steam, in particular across the mixing chamber into the combustion chamber. Moreover, the present invention relates to an aircraft that includes such a drive system.

### SUMMARY OF THE INVENTION

During takeoff and climbing of such drive systems, it is challenging to recover enough water to maintain an open Cheng cycle. For this reason, large quantities of water must be carried along in tanks for these flight phases. In addition, compared to a conventional aircraft engine, numerous additional components must be accommodated, which makes the integration into the drive system and the integration of the drive system into the aircraft more difficult. For the aircraft fuselage design, a configuration is preferred which approaches conventional aircraft engines as closely as possible with regard to the size, the center of gravity, and the flow behavior at the wing.

Furthermore, in a turbomachine-based aircraft engine it is challenging to guide the streaming of the core flow and the bypass flow through the heat exchanger of a Cheng cycle while meeting the requirements for pressure losses and the installed volume of the engine. This concerns in particular the condenser of the steam system, via which the combination of the exhaust gas and the condensate is cooled by a cooling flow from the bypass flow or the ram air.

An object of the present invention is to provide a drive system and an aircraft whose efficiencies are further increased.

A drive system according to the present invention includes a gas turbine that is designed in particular as an aircraft engine, the gas turbine including a core flow channel in which at least one compressor, in particular a mixing chamber, a combustion chamber, and a turbine, are situated in the flow direction, and including a steam system for separating water from an exhaust gas stream of the core flow channel, for generating steam, and for conveying the steam, in particular across the mixing chamber into the combustion chamber.

The present invention provides that the steam system is coupled to a separate cooling system in order to contribute to the separation of the water for generating the steam from an exhaust gas stream of the core flow channel, via absorption and discharge of heat. Due to the coupling, the heat dissipation is improved, thereby increasing the water separation and thus the possible steam generation, which advantageously increases the overall efficiency.

The steam system may include a water separation device, an evaporator which may be designed as a heat exchanger, and a steam turbine. A water separation device may be designed to condense water from the exhaust gas of the core flow channel. The water may then be led into the evaporator, which utilizes the waste heat from the exhaust gas from the core flow channel to evaporate the water. The in particular superheated steam may then be led into the steam turbine in order to recover additional mechanical energy for the drive system. The steam turbine may be coupled to a shaft of the gas turbine via a gear. Lastly, the steam may be led into a mixing chamber and/or directly into the combustion chamber in order to increase the specific power of the aircraft engine.

Further advantages and features result from the following description of several preferred exemplary embodiments.

In one advantageous specific embodiment of the drive system, the cooling system has a closed design. The coolant is advantageously retained in this way, resulting in lower costs and reduced complexity. For this purpose, the cooling system may have a reservoir for the coolant. The coolant may be circulated in the cooling system by a pump. The pump may be electrically or mechanically driven by a shaft of the gas turbine or by a steam turbine shaft of the steam turbine. An additional advantage results during takeoff, when the system is controlled in such a way that the coolant and the reservoir are utilized as a heat sink; i.e., they heat up in the course of takeoff.

In a further advantageous specific embodiment of the drive system, the steam system includes at least one evaporator, and the cooling system includes a heat exchanger, it being possible for the heat exchanger to be situated in an exhaust gas stream of the core flow channel, downstream from or next to the evaporator. In this way, the water-containing exhaust gas stream is cooled to a lower temperature and the relative humidity in the exhaust gas stream thus increases, so that the separation of water is advantageously improved. Due to the arrangement downstream from or next to the evaporator, use is advantageously made of the evaporation process in the evaporator before the exhaust gas stream is further cooled. The heat exchanger may preferably be a condenser. The mass flow of the cooling fluid of the heat exchanger may preferably be utilized to advantageously control the drive system with regard to its thermal load. The drive system may thus include a control system and/or a control device. The control device may in particular be the above-mentioned pump.

In a further specific embodiment of the drive system, the cooling system utilizes a coolant, and includes an auxiliary cooler for cooling the coolant. The ability of the cooling system to cool the exhaust gas stream is advantageously improved by an auxiliary cooler. The coolant in particular may circulate in the cooling system, in particular when the cooling system as a whole has a closed design, so that the cooling capability is further increased, and advantageously only a minimal quantity of coolant has to be taken along. The coolant may be an ethylene glycol-water mixture or water. The auxiliary cooler may be designed as a heat exchanger, in particular in a cross-counterflow architecture. This requires a smaller number of transfer units (NTUs) for the same efficiency, as well as lesser pressure losses on the cold side of the heat exchanger.

In one preferred refinement of the drive system, the auxiliary cooler for cooling the coolant may be situated in the gas turbine. By situating the auxiliary cooler in the gas turbine, the length of the pipelines for transporting the coolant to the heat exchanger of the cooling system may be minimized, so that power losses are advantageously minimized, and the manufacture of the drive system may take place with lower costs.

In one particularly preferred refinement of the drive system, the auxiliary cooler is situated in and/or at the bypass flow channel, and/or in and/or at a pipeline system of the gas turbine. Due to situating the auxiliary cooler at least partially in and/or at the bypass flow channel, use may be made of an air stream of the bypass flow in an advantageously simple manner in order to discharge the heat from the cooling system. In addition, at least partial arrangement of the auxiliary cooler in and/or at a pipeline system of the gas turbine may be utilized to lead the waste heat out of the cooling system in an advantageously targeted manner, at the same time it also being advantageously possible to heat gases or liquids in the piping system to allow their viscosity to be influenced in an advantageously targeted manner by temperature adjustment.

In one alternative refinement of the drive system, the auxiliary cooler for cooling the coolant may be situated in an external additional nacelle outside the gas turbine. Due to situating the auxiliary cooler in an additional nacelle, the cooling of the coolant may be made more efficient, since the relatively high temperatures prevailing in the main nacelle have no influence on the cooling, and the lower ambient temperature during flight may be utilized to discharge the waste heat. In addition, due to the spatial separation, the manufacture and design of a main nacelle of the aircraft engine are advantageously simplified despite the presence of the cooling system.

In one particular refinement, at least one additional rotor (compressor) for cooling the auxiliary cooler may be situated upstream and/or downstream from the auxiliary cooler. Such an active cooling device advantageously achieves better cooling power of the auxiliary cooler, so that greater quantities of heat may be discharged, and the proportion of separated water in the heat exchanger may be increased. The at least one additional rotor, in particular in the additional nacelle, may be part of a compressor, of a drive, and/or of a blower. A plurality of additional rotors may also be provided.

The auxiliary rotor may particularly preferably be driven by a steam turbine of the steam system. The steam system and the cooling system are thus advantageously more highly integrated with one another, and at the same time the cooling power of the cooling system is increased. The auxiliary rotor may in particular be situated on a steam turbine shaft of the steam turbine. The longitudinal axis of the steam turbine shaft may preferably be situated radially spaced apart with respect to a longitudinal axis of a shaft of the aircraft engine.

In addition, the drive system may be further refined by having the auxiliary rotor be driven by an electric motor. The use of an electric motor advantageously allows particularly simple control of the auxiliary rotor, and an advantageously freely selectable arrangement of the auxiliary rotor and of the electric motor in the drive system, which advantageously simplifies the design of the drive system.

In one advantageous refinement of the drive system, it is provided that the electric motor is connected to an electrical system and/or is part of the electrical system, that the electrical system is supplied with electrical power by a generator, and that the generator is driven by a steam turbine of the steam system or by the turbine of the aircraft engine. This specific embodiment also allows simple integration of the steam system and of the cooling system into the existing architecture of the drive system. In particular when a pump is used in the cooling system, it may be provided that the pump is connected to the electrical system and is supplied with power by the electrical system.

A further aspect of the present invention relates to an aircraft that includes one of the drive systems described above, the gas turbine being an aircraft engine.

In a further specific embodiment of the aircraft that includes a fuselage and a drive system, and that is designed with an auxiliary cooler situated in an additional nacelle, it is provided that the additional nacelle is situated at or below the fuselage. Additional air resistance and additional weight at the wings may thus be avoided. Furthermore, an additional nacelle that is in particular centered at the fuselage, together with the auxiliary cooler, may simultaneously provide all aircraft engines with cooling. The additional nacelle may be integrated into the fuselage and/or may be part of a housing of the fuselage.

In one preferred specific embodiment of the aircraft that includes a wing and a drive system, and that is designed with an auxiliary cooler situated in an additional nacelle, it may be provided that the additional nacelle is situated at or below the wing, in particular at a pylon.

In addition, in a further specific embodiment of the aircraft it may be provided that the additional nacelle in the transverse direction is situated farther from a longitudinal axis of the aircraft than is the gas turbine.

### BRIEF DESCRIPTION OF THE DRAWINGS

The present invention is explained in greater detail with reference to the following drawings, based on several preferred exemplary embodiments of the present invention.

FIG. 1 shows a first exemplary embodiment of a drive system according to the present invention in a schematic top view;

FIG. 2 shows a second exemplary embodiment of a drive system according to the present invention in a schematic top view;

FIG. 3 shows a third exemplary embodiment of a drive system according to the present invention in a schematic top view;

FIG. 4 shows a fourth exemplary embodiment of a drive system according to the present invention in a schematic top view;

FIG. 5 shows a fifth exemplary embodiment of a drive system according to the present invention in a schematic top view;

FIG. 6 shows a sixth exemplary embodiment of a drive system according to the present invention in a schematic top view;

FIG. 7 shows a first exemplary embodiment of an aircraft according to the present invention, together with a drive system according to the present invention; and

FIG. 8 shows a second exemplary embodiment of an aircraft according to the present invention, together with a drive system according to the present invention.

### DETAILED DESCRIPTION

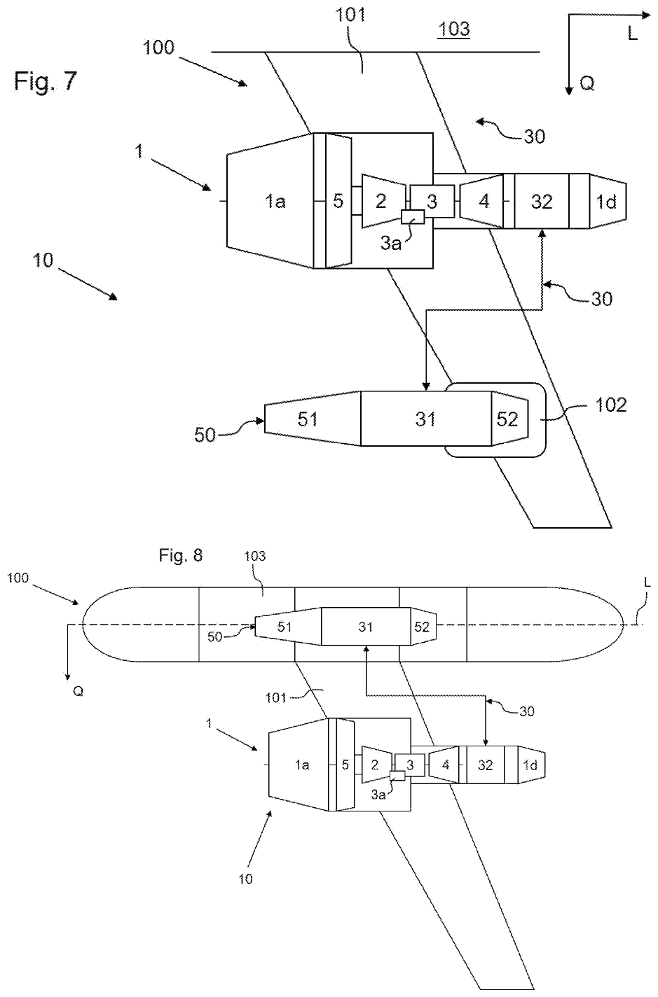

FIGS. 1 through 6 in each case schematically illustrate a gas turbine 1 designed as an aircraft engine 1, in a meridional section that is visible from above. The common features are described first. FIGS. 7 and 8 illustrate two exemplary embodiments of an aircraft 100 according to the present invention in a top view. Aircraft engine 1 and its components are described in a cylindrical coordinate system which is fixed to the shaft, and which includes an axial direction Ax, a radial direction R, and a circumferential direction U. Aircraft 100 is described with reference to longitudinal axis L, transverse axis Q, and a vertical axis. Auxiliary cooling circuit 30 is illustrated in dashed lines to allow the components of the individual subsystems to be better distinguished from one another.

In axial direction Ax, aircraft engine 1 includes an engine intake 1a at the front, downstream from which flow passes through a bypass flow channel 1b and a core flow channel 1c. Bypass flow channel 1b is used to generate thrust, and core flow channel 1c is used primarily to generate energy for the components of aircraft engine 1 and/or to supply cabin systems of aircraft 100, illustrated in FIG. 7 or 8, for example, with electrical power and fresh air. Situated in sequence in core flow channel 1c are the main components of aircraft engine 1, namely, a compressor 2, a combustion chamber 3, and a turbine 4 including a low-pressure turbine 4b. A fan 5 for aspiration of air and first compression of air may be situated in engine intake 1a, a portion of the air, aspirated and compressed by fan 5, flowing into core flow channel 1c, where it is highly compressed by compressor 2. Aircraft engine 1 includes an outer housing 6 that encloses engine intake 1a and bypass flow channel 1b, and an intermediate housing 7 that separates bypass flow channel 1b and core flow channel 1c. Outer housing 6 forms a nacelle, also referred to as a cowling. Fan 5, compressor 2, and turbine 4 are mechanically coupled via at least one shaft 8 that rotates about an engine rotational axis 8a, it also being possible for fan 5 and optionally front low-pressure compressor stages (not separately illustrated) of the faster-running turbine 4 to be decoupled by a gear 9. In addition, fuel is admixed in combustion chamber 3, and the fuel-gas mixture is ignited. The hot gas is subsequently led out of combustion chamber 3 and into turbine 4, and in turbine 4 is expanded for driving the at least one shaft 8.

Aircraft engine 1 includes a steam system 20 which is designed at least for separating water from the exhaust gas stream of core flow channel 1c and evaporating the water. A water separation device 21 designed as a heat exchanger is provided for separating the water, and an evaporator 22, situated in the exhaust gas stream of core flow channel 1c, is provided for evaporating the water. In the present exemplary embodiments according to FIGS. 1 through 6, in addition a steam turbine 23 is provided, which is either situated on shaft 8 or may include an additional steam turbine shaft 23a.

In the present specific embodiments, an additional mixing chamber 3a is situated upstream from combustion chamber 3, over which flow passes downstream from steam turbine 23 and compressor 3 and which mixes the steam and the compressed air and leads the air-steam mixture into combustion chamber 3. In an alternative specific embodiment, the steam from steam system 20 may also be fed directly into the combustion chamber.

The hot exhaust gas flows from turbine 4, in particular from low-pressure turbine 4b, into and through the subsequent components of steam system 20 and of an auxiliary cooling circuit 30 according to the present invention. In the present exemplary embodiments, the exhaust gas is not directly emitted from core flow channel 1c, and instead is aftertreated in steam system 20 including a water separation device 21 and an evaporator 22; a heat exchanger 32 of the cooling system, designed as a condenser, is situated between evaporator 22, situated first in the exhaust gas stream, and water separation device 21 situated downstream. Heat exchanger 32 and water separation device 21 may be referred to jointly as a water recovery system 21, 32. Water recovery system 21, 32 recovers water from the exhaust gas of the core flow, and feeds water to steam system 20. At least one water tank may optionally be provided for supplying the steam system with water. The steam system may also optionally include a water pump that conveys water to the evaporator.

Heat exchanger 32, designed as a condenser, is preferably cooled by a coolant and in particular has a closed design. In the exemplary embodiments, an auxiliary cooler 31 designed as a heat exchanger is provided for cooling the coolant. For example, an ethylene glycol-water mixture or water or some other suitable fluid may be used as coolant, in particular independently of its phase state. Auxiliary cooler 31 may be designed in a cross-counterflow architecture.

In the first exemplary embodiment according to FIG. 1, steam system 20 and auxiliary cooling circuit 30 are both completely situated in aircraft engine 1. Auxiliary cooling circuit 30 may also include a reservoir 33 for the coolant and a pump 34 for conveying the coolant.

As a result of heat exchanger 32 being introduced directly into the exhaust gas stream of core flow channel 1c and cooling the exhaust gas, the discharge rate of the water in the subsequent water separation device is improved. Heat exchanger 32 may have a much smaller design in this configuration. This means that the heat exchanger may be integrated directly downstream from or next to evaporator 22, and does not have to be relocated into the bypass flow channel or pipelines. This allows axial guiding of the core flow. The mass flow of the cooling fluid of heat exchanger 32 may preferably be utilized to advantageously control the system with regard to its thermal load.

Various configurations of steam system 20 and of auxiliary cooling circuit 30 according to the present invention are described in greater detail below, with reference to the first through sixth exemplary embodiments of drive system 10 according to FIGS. 1 through 6.

In the first exemplary embodiment of drive system 10 according to the present invention according to FIG. 1, auxiliary cooler 31 for cooling the cooling medium is situated in bypass flow channel 1b, upstream from an outlet 1b′ of bypass flow channel 1b. As a result, the air flow in bypass flow channel 1b is directly utilized for releasing heat. The heating of the bypass flow increases its temperature, and thus increases the thrust of the bypass flow. Depending on the configuration, this increase in thrust may advantageously at least partially compensate for the pressure loss through the heat exchanger.

In one specific embodiment, it may also be provided that auxiliary cooler 31 is situated in separate pipelines or channels, and ambient air flows over it via ram air and/or an additional compressor. These separate channels do not necessarily have to have a physical connection with the actual engine.

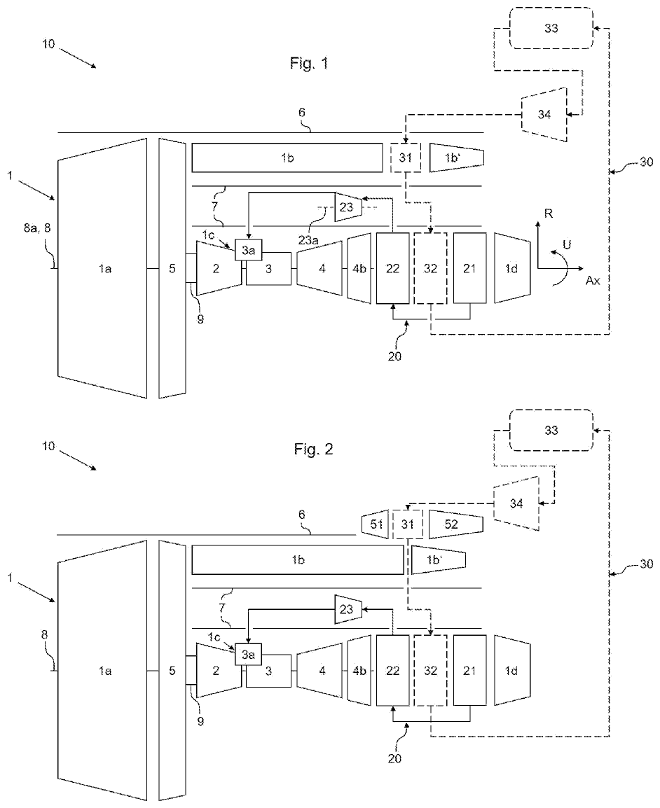

In the second exemplary embodiment according to FIG. 2, drive system 10 according to the present invention includes an additional nacelle 50 with an air inlet 51 and an air outlet 52; auxiliary cooler 31, in contrast to the first exemplary embodiment, is situated in additional nacelle 50 between air inlet 51 and air outlet 52, in the air stream there. Additional nacelle 50, as illustrated in the exemplary embodiment, may be designed as part of outer housing 6 of aircraft engine 1. However, it may also be provided that the additional nacelle is situated separately and spaced apart from aircraft engine 1. Due to the advantageous arrangement of auxiliary cooler 31 in the additional nacelle, the coolant is cooled without bypass flow channel 1b having to be adapted.

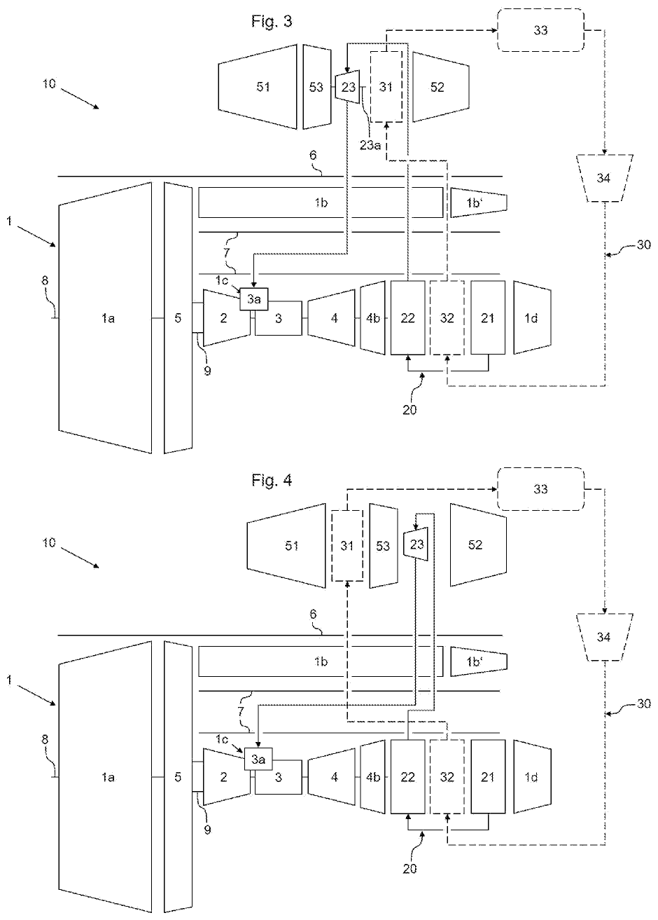

In the third exemplary embodiment according to FIG. 3, drive system 10 according to the present invention likewise includes an additional nacelle 50 with an air inlet 51 and an air outlet 52. In contrast to the second exemplary embodiment, additional nacelle 50 is situated at a distance from engine 1. In addition, steam turbine 23 is situated in the additional nacelle, where via a steam turbine shaft 23a it drives an auxiliary rotor 53, which passes a flow of ambient air over the auxiliary cooler 31 and thus advantageously achieves very high cooling power. Auxiliary rotor 53 may be, for example, a compressor, a drive, or a blower, or a part of these apparatuses. If auxiliary rotor 53 is designed as a drive, additional nacelle 50 may advantageously generate thrust.

Lines may be provided in a wing 101 of aircraft 100 in order to transport the steam from the steam turbine into mixing chamber 3a.

The fourth exemplary embodiment according to FIG. 4 largely corresponds to the third exemplary embodiment, except that auxiliary cooler 31, in contrast to the third exemplary embodiment, is situated in additional nacelle 50, in front of auxiliary rotor 53 in the flow direction. Auxiliary rotor 53 generates suction, and advantageously draws the ambient air through auxiliary cooler 31. As a result, the temperature difference between the fresh ambient air and the coolant to be cooled is greater, which has an advantageous effect on the heat transfer in auxiliary cooler 31. In this fourth exemplary embodiment as well, auxiliary rotor 53 is driven by steam turbine 23.

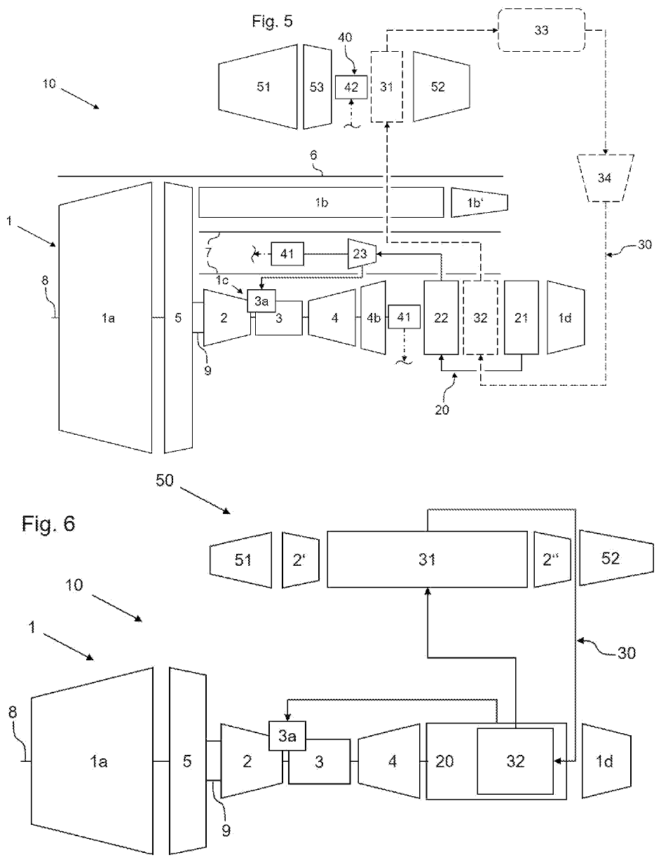

In the fifth exemplary embodiment of the drive system according to FIG. 5, the drive of auxiliary rotor 53 is achieved by an electric motor 42 of an electrical system 40. In this particular exemplary embodiment, electrical system 40 obtains the electrical power from two generators 41 that are driven on the one hand by steam turbine 23 and on the other hand by shaft 8 of aircraft engine 1. Generators 41 are connected to electric motor 42 via electrical lines. The lines of electrical system 40 are illustrated as dash-dotted lines. In addition, it may be provided that at least one of generators 41 of electrical system 40 supplies an electrical cabin system (not shown) and/or an aircraft battery (not shown) with power. The steam turbine may thus be advantageously used as an auxiliary power unit (APU). It is understood that it is also possible for only one of the two generators 41 to be present. Pump 34 of auxiliary cooling system 30 may also be supplied with power by electrical system 40, and thus operated.

FIG. 6 shows a sixth exemplary embodiment of the drive system, in which in the air stream a first additional compressor 2′ is situated upstream from, and/or a second additional compressor 2″ is situated downstream from, auxiliary cooler 31 in additional nacelle 50. For the sake of simplicity, the components of steam system 20 and the further components of the cooling system, namely, reservoir 33 and pump 34, are not shown.

FIG. 7 shows a schematically illustrated first exemplary embodiment of an aircraft 100 according to the present invention in a top view. One of the two wings 101 of aircraft 100 is shown; aircraft engine 1 and an additional nacelle 50 with an auxiliary cooler, described above for FIGS. 4 through 6, are situated at wing 101. In the present first exemplary embodiment, additional nacelle 50 is fastened to a pylon 102, and is connected to wing 101 via pylon 102. Additional nacelle 50 is advantageously situated farther from a fuselage 103 of aircraft 100 in transverse direction Q than is aircraft engine 1.

FIG. 8 shows a schematically illustrated second exemplary embodiment of an aircraft 100 according to the present invention in a top view. Compared to the first exemplary embodiment of aircraft 100, additional nacelle 50 is situated below fuselage 103 of aircraft 100.

Additional nacelle 50 may be a single additional nacelle 50 whose auxiliary cooler 31 cools, via the coolant, heat exchangers 32 of cooling systems 30 of two or four aircraft engines 1.

### LIST OF REFERENCE SYMBOLS

1 gas turbine, aircraft engine
1a intake
1b bypass flow channel
1b′ bypass flow channel outlet
1c core flow channel
1d engine outlet
2 compressor
3 combustion chamber
4 turbine
4b low-pressure turbine
5 fan
6 outer housing, main nacelle
7 intermediate housing
8 shaft
8a engine rotational axis
9 gear
10 drive system
20 steam system
21 water separation device
22 evaporator
23 steam turbine
30 auxiliary cooling circuit
31 auxiliary cooler
32 heat exchanger, condenser
33 reservoir
34 pump
40 electrical system
41 generator
42 electric motor
50 additional nacelle
51 inlet of the additional nacelle
52 outlet of the additional nacelle
53 auxiliary rotor
100 aircraft
101 wing
102 pylon
103 fuselage
Ax axial direction
R radial direction
U circumferential direction
L longitudinal axis of the aircraft
Q transverse axis of the aircraft

What is claimed is:

1. A drive system comprising:
a gas turbine, the gas turbine including a core flow channel, with at least one compressor, a combustion chamber, and a turbine being situated in the core flow channel in the flow direction; and
a steam system for separating water from an exhaust gas stream of the core flow channel, for generating steam, and for conveying the steam, in particular across the mixing chamber into the combustion chamber; and
a separate cooling system coupled to the steam system in order to contribute to separation of the water for generating the steam from an exhaust gas stream of the core flow channel, via absorption and discharge of heat.

2. The drive system as recited in claim 1 wherein the cooling system has a closed design.

3. The drive system as recited in claim 1 wherein the steam system includes at least one evaporator, and the cooling system includes a heat exchanger, the heat exchanger being situated in an exhaust gas stream of the core flow channel, downstream from or next to the evaporator.

4. The drive system as recited in claim 1 wherein the cooling system utilizes a coolant, and includes an auxiliary cooler for cooling the coolant.

5. The drive system as recited in claim 4 wherein the auxiliary cooler for cooling the coolant is situated in the gas turbine.

6. The drive system as recited in claim 5 wherein the auxiliary cooler is situated in or at the bypass flow channel or in or at a pipeline system of the gas turbine.

7. The drive system as recited in claim 4 wherein the auxiliary cooler for cooling the coolant is situated in an external additional nacelle outside the gas turbine.

8. The drive system as recited in claim 4 further comprising at least one auxiliary rotor for cooling the auxiliary cooler and situated upstream or downstream from the auxiliary cooler.

9. The drive system as recited in claim 8 wherein the auxiliary rotor is driven by a steam turbine of the steam system.

10. The drive system as recited in claim 8 wherein the auxiliary rotor is driven by an electric motor.

11. The drive system as recited in claim 10 wherein the electric motor is connected to an electrical system or is part of the electrical system, the electrical system being supplied with electrical power by a generator, and the generator being driven by a steam turbine of the steam system or by the turbine of the gas turbine.

12. The drive system as recited in claim 1 wherein the gas turbine is an aircraft engine.

13. The drive system as recited in claim 1 wherein the gas turbine has a mixing chamber situated in the core flow channel.

14. An aircraft comprising the drive system as recited in claim 1, the gas turbine being an aircraft engine.

15. The aircraft as recited in claim 14 further comprising a fuselage, wherein the cooling system utilizes a coolant, and includes an auxiliary cooler for cooling the coolant situated in an external additional nacelle outside the gas turbine, the additional nacelle being situated at or below the fuselage.

16. The aircraft as recited in claim 14 further comprising a wing, wherein the cooling system utilizes a coolant, and includes an auxiliary cooler for cooling the coolant situated in an external additional nacelle outside the gas turbine, the additional nacelle being is situated at or below the wing.

17. The aircraft as recited in claim 16 wherein the additional nacelle is situated at a pylon.

18. The aircraft as recited in claim 16 wherein the additional nacelle in the transverse direction is situated farther from a longitudinal axis of the aircraft than is the aircraft engine.
